(19) United States
(12) Patent Application Publication
(10) Pub. No.: US 2009/0271309 A1
(43) Pub. Date: Oct. 29, 2009

(54) MEDIA EXCHANGE SYSTEM AND METHOD

(76) Inventors: Christopher Scott Gordon, Bellingham, WA (US); Clifford Daniel Gordon, Spannaway, WA (US); Sean Simmons, Bellingham, WA (US); Aaron Raddich, Ellensburg, WA (US)

Correspondence Address: Jellett Law, PS;Matthew Jellett, Esq., 910 Harris Ave, Suite A205, BELLINGHAM, WA, 98225, US

(21) Appl. No.: 12/111,091

(22) Filed: Apr. 28, 2008

(51) Int. Cl. G06Q 30/00; G06Q 99/00

(52) U.S. Cl. 705/37; 705/1

(57) ABSTRACT

A media exchange. The media exchange uses an exchange database. The database supports interoperation between an exchange component, a media user component and a first media provider component. The media user component enables a media client to access a media component. The media component is supplied from a media provider client using the media provider component. The media user component enables the media client to enable the media component and accrue a first media value. The media user component enables the first media client to also access a second media component associated with a second media value. This is done by exchanging the first media value for the second media value.

### BACKGROUND

U.S. Pat. No. 5,933,811 discloses a system and method for delivering customized advertisements with an interactive communication system. Referring to the Summary of the Invention section in column 3 around line 18, “a consumer who wishes to receive customized advertisements first registers with the advertisement provider by entering pertinent demographic information into the advertisement provider's demographic database.” Further on, “the advertisement provider assigns a consumer unique member code. In the alternative embodiment, the consumer is sent unique software which enhances the consumer's Internet browser so that customized advertisements can be merged with electronic documents obtained from the content provider.” In the abstract, towards the bottom of the paragraph, “the custom advertisements are then combined with the offering from the content provider computer and displayed to the consumer. The advertisement provider computer also credits a consumer account, content provider account and an Internet provider account each time a consumer views a custom advertisement. Furthermore, the advertisement provider computer tracks consumer responses to the customized advertisements.”

U.S. Pat. No. 5,794,210 discloses an attention brokerage system. Referring to the Summary of the Invention section in column 5 around line 37, “the “cyber coin” transaction reflects . . . advertisers [which] have elected to sponsor the consumer who selects the cyber coin that is, they have chosen to pay the consumer directly for her attention rather than using the same funds from mass-market ad campaigns . . . ” Furthermore in column 6 around line 3, “the present invention also introduces the concept of “negative pricing of information.” . . . “negatively priced information” pays the consumer for his or her attention.”

US2001/0034649 discloses a method and system for allocating and redeeming tokens. A web site displays a web page with an advertisement which includes an indication that a token of the token service will be allocated to the user when the user selects i.e. clicks through, the advertisement.

U.S. Pat. No. 7,240,022 discloses a demographic information gathering and incentive award system and method where a web site proprietor gains demographic information about the users that visit their websites and provides website visitors with incentive awards in exchange for providing the demographic information and interacting with the website in a predefined manner.

U.S. Pat. No. 7,054,831 discloses a system and method for combining an interactive game with interactive advertising. In the Summary of the Invention section in column 2 around line 24, “the present invention provides a combination multimedia interactive game and infomercial, wherein a player and/or participate users are required to access and research product information as the interactive media game is played.”

U.S. Pat. No. 7,025,674 discloses a method and apparatus for awarding and redeeming promotional points in an electronic game.

U.S. Pat. No. 6,766,524 discloses a system and method to encourage viewers to watch television programs. In the Summary of the Invention section in column 2 around line 3, “to verify that the viewer paid attention, the answer to the question may be based on content of the program. A sponsor of a TV commercial might ask, for example, that the viewer identify the name of the sponsor or the color of the announcer's shirt.” Further down in column 2 around line 11, “in other embodiments, viewers need not provide a correct answer, but may be rewarded for merely participating in the interactive program. Such participation may include selecting an icon with a pointing device, pressing one or more buttons on a remote control, or sending an e-mail message to a location identified in the program.”

U.S. Pat. No. 6,385,592 discloses a system and method for delivering customized advertisements within interactive communication systems, whereas seen in the Summary of the Invention section, around line 50, “the present invention overcomes difficulties discussed above by providing an online advertising service which can custom tailor specific advertisements to particular consumers and track consumer responses to the advertisements.” Further down around line 60, “the entities include: a content provider, an advertisement provider and a consumer.”

U.S. Pat. No. 6,183,366 discloses a network gaming system, where in the Summary of the Invention section in column 3 around line 65, “the present invention is computerized interactive advertising system for exchanging information regarding goods and/or services between a first population of users such as players, and a second population of users such as sponsors. In particular, the sponsors or advertisers may present information relating to goods and/or services to the players using the present invention and players may view this information while for example, interacting with the present invention for playing a game such as blackjack etc.” Further down at line 14, “thus, the present invention provides an information exchange service within a gaming context for enticing players to view and/or interact with sponsor presentation such as interactive advertisements.”

U.S. Pat. No. 5,916,024 discloses a system and method of playing games and rewarding successful players, where in the Summary of the Invention section, in column 2 around line 49, “in accordance with the invention, the system provides for the transmission of signals designating conditions of the game playing and, in the case of scenarios, games or other events upon which a person may wish to bet. The system provides questions and response criteria along with a transmission of the broadcast program. In the event of questions or similar tasks, signals may be recorded prior to transmission and may be transmitted at a fixed predetermined time, or upon request of the person who will respond to program and/or questions.”

U.S. Pat. No. 5,855,008 discloses an attention brokerage system, where as seen in the Summary of the Invention section in column 4 around line 46, “the present invention provides mechanisms for attention brokerage, the business of buying and selling [brokering] the “attention” of consumers, thereby maximizing efficiency and creating value”. Further down in column 5 around line 30, “since all the ads on the list will be targeted to the consumer's needs, interest, and preferences, it is very likely that she would be inclined to view them even without a cash incentive. However, the system provided by the present invention will offer her one. The present invention provides a “consumer interface button” for example, the image of a little gold coin [“CyberCoin”] next to each title on a list This use of a consumer interface button, CyberCoin, though reminiscent of the prior “gems” in videogame adventures, is innovative and unique in that it transfers real value.”

### BRIEF DESCRIPTION OF THE DRAWINGS

FIG. 1 is a schematic view of the media exchange;

FIG. 2 is a system diagram of the media exchange server, database and applications;

FIG. 3A is a system diagram showing a dual party exchange operation;

FIG. 3B is a system diagram showing a three party exchange operation;

FIG. 4 is a schematic diagram of the media user application and database;

FIG. 4A is a schematic diagram of the media user application user session components;

FIG. 4B is a schematic diagram of the media user application submenu components;

FIG. 5 is a schematic diagram of the provider application, media provider application, components and database;

FIG. 6 is a schematic diagram of the provider application, advertising provider application, components and database;

FIG. 7 is a perspective view of the media user application navigation interface;

FIG. 8A is an elevational view of the media user application navigation interface and media matrix;

FIG. 8B is a schematic perspective view of the provider application interoperating with the media user application navigation interface;

FIG. 10A is a flowchart of the advertising provider process;

FIG. 10B is a flowchart of the advertising media management process;

FIG. 10C is a flowchart of the advertising campaign management process;

FIG. 11 is a flowchart of the media provider process;

FIG. 12 is a flowchart of the media user process.

### DESCRIPTION

Generally speaking, this concept deals with the field of entertainment and specifically with providing free media to media users through various entertainment media and advertising media mechanisms. Furthermore a media exchange system is provided which enables: users to access media; advertisers to sponsor media; and content providers or entertainment media providers to provide users access to media. In doing so, a two-party or three party exchange is utilized depending on the type of media being provided. For example, one embodiment may include a provider of the media offering advertising as well as entertainment content where the user of the entertainment content first accesses the advertising media to develop a positive media value, and then utilizes this positive media value to access the entertainment content from the same media provider.

A second embodiment includes a provider of the entertainment media, a provider of the advertising media, and a user of the media or of the advertising. The user or consumer views or accesses the advertisement from the advertising provider, accumulates a positive media value, and uses the positive media value to later access entertainment media associated with a negative media value.

As an incentive for the media users and media providers to utilize the exchange, a plurality of media components have been developed which are utilized to produce a highly visceral media experience. From the media provider's standpoint, the exchange enables him to develop media with the opportunity to give the media user a visceral experience in exchange for the media user's time or media value. From the media user's standpoint, the exchange enables the media user to spend time with various types of media provided through the visceral experience of the exchange.

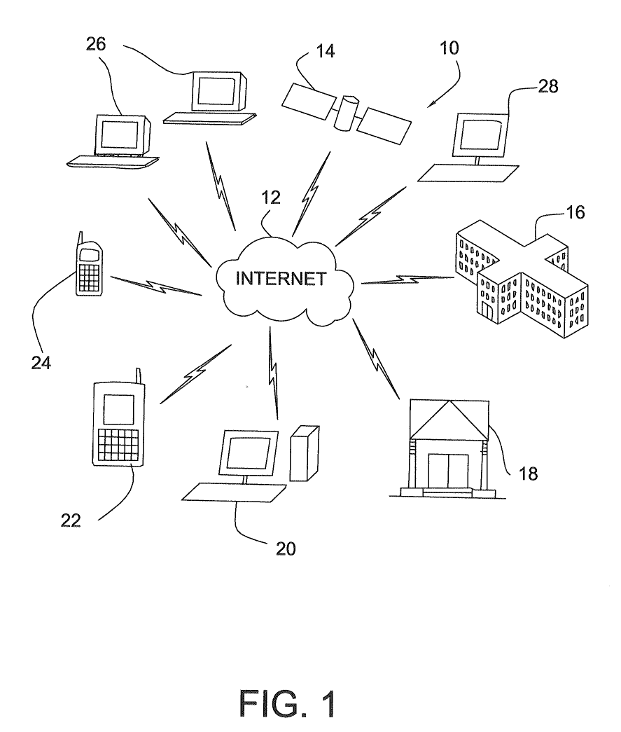

To accomplish these ends, and referring to FIG. 1, a media exchange 10 is provided where a plurality of media providers 26 have access to a network 12 such as the Internet, which provides access to the media exchange server or servers 20. Furthermore, other outside entities including financial institutions 18, advertising providers 16, user client computers 28, including laptops, desktops, other servers, PC and Mac as well as Linux systems, tablet pc's etc. . . . , communication devices such as hand held wireless technologies 24 which include various types of cell phones such as the iPhone, Nokia phones, Motorola phones etc., and PDAs 22, all connected to the network via standard networking technology.

The client computers 28 have access to the exchange server 20 through the network 12. The exchange server 20 may be a single server located at a single location, multiple servers located at a single location or at multiple locations, or a distributed set of peer-to-peer servers providing for example a bitTorrent type of content delivery system. Furthermore, the network itself 12 is not limited to any particular type of network. For example, the network may utilize a local area network or (LAN) a wide-area network or (WAN) such as the Internet. Various protocols may be utilized such as an Internet protocol, TCP/IP protocol, frame relay protocol, FTP, HTTP, XML, various ASP protocols etc. Other networks such as telephone networks, cellular phone networks, or any combination of the above may be utilized. Furthermore, various types of databases can be used such as mySQL, Microsoft's SQL, Access, Oracle or other standard database technology.

The applications discussed herein may be executed partially or wholly on a local computer or remotely and may be coded using for example, C++, C#, Microsoft Visual Basic, Javascript and any other object-oriented or non-object oriented programming language available now or in the future. Furthermore, the applications themselves may also be provided as Web applications such as Unity3D enabled applications, Flash enabled applications, Java-enabled applications, HTML utilizing active server pages, XML utilizing active server pages, and combining multimedia components such as Adobe flash, or three-dimensional game engines such as Unity 3D.

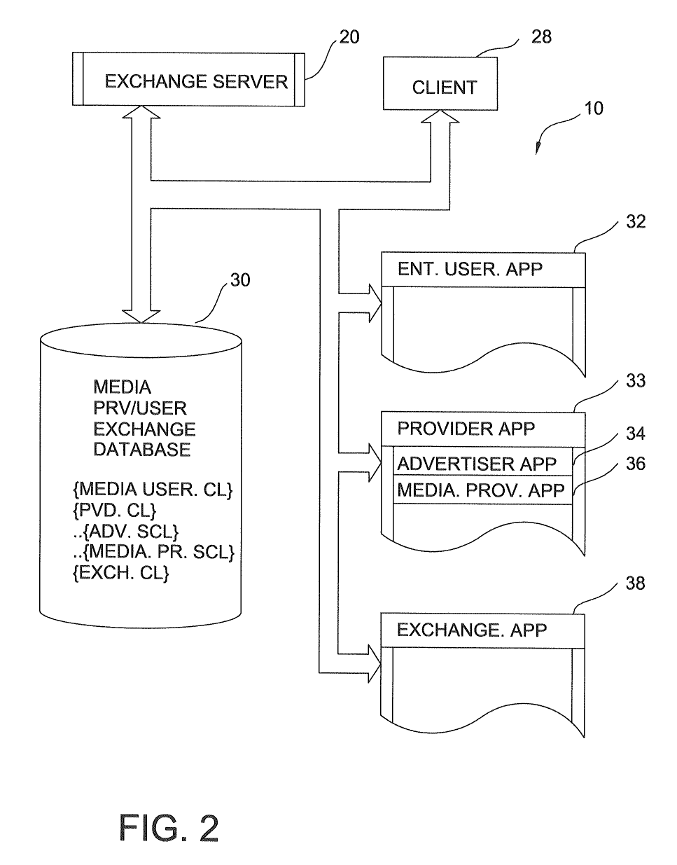

Referring to FIG. 2, the exchange server 20 in one embodiment hosts the exchange database 30 which enables the provider and user applications to access stored and shareable information including the media. In the database, there is information such as a media user class and a provider class (having an advertising provider subclass, a media provider subclass), and also the database holding an exchange class.

The clients 28 has access to the exchange server through the network 12, and depending on the purpose for accessing the exchange server, the client may be able to execute an entertainment user application or component 32, a provider application or component 33, or an exchange application or component 38. The provider application 33 has two main executable sub applications or subcomponents, including previously indicated advertiser application or component 34 and a media provider application or component 36. The media exchange 10 being executable wholly within a local area network through the use of various client computers, executable through the Internet, or a combination of the two.

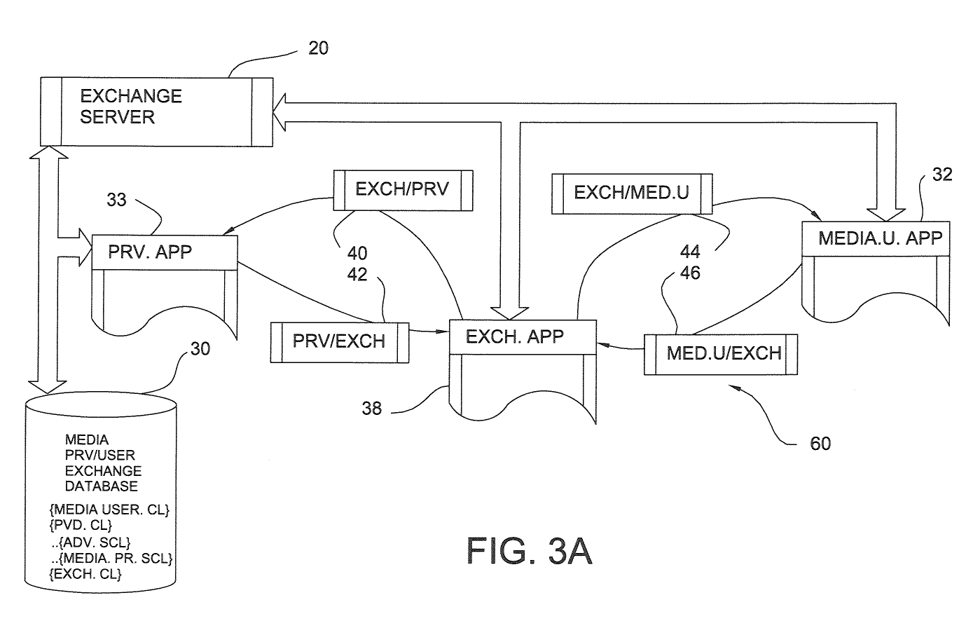

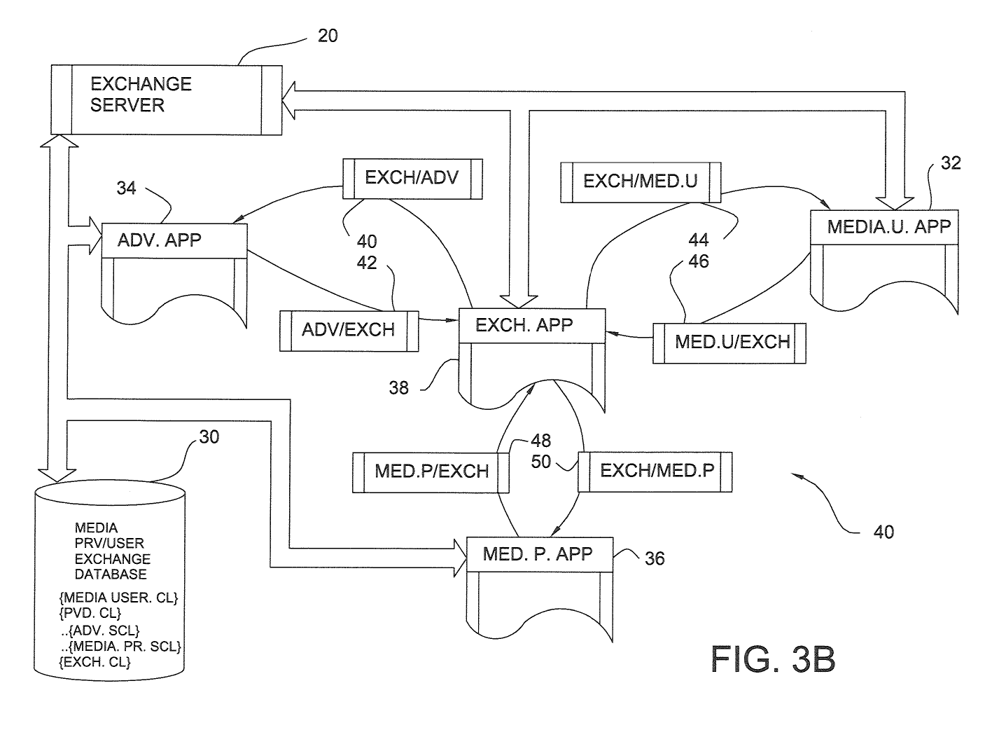

In one embodiment, the exchange server supports and handles the media exchange between the provider and the media user. Referring to FIG. 3A, a dual party exchange operation 60 is shown where the exchange server 20 is supporting the exchange between the provider application 33 and a media user application 32 through the use of the exchange application 38. The provider application 33 has been initialized and executed from the exchange database 30. The provider application or provider component 33 may be hosted on a remote user client, hosted partially on the exchange server and partially on remote clients, such as through a Web application, or fully hosted on the exchange server and being remotely executed through Web application interface such as will be discussed below. Similarly, the media user application 32 or media user component 32, may be fully hosted on the remote client computer, partially hosted on the exchange server 20 and partially hosted on the remote client 28, or fully hosted and executed off of the exchange server utilizing a Web application interface. Furthermore, portions of the applications may be executed or hosted from multiple remote servers as previously discussed above.

In order to coordinate the exchange, the exchange application 38 or exchange component 38 brokers the exchange of media, information, and media value between the provider application 33 and the media user application 32. Before discussing in detail the various exchange operations, for this dual party exchange operation 60, a brief discussion of the overall exchange will take place.

In order for the media user application 32 to access media, the provider application 33 must first provide media through a provider/exchange process 42. Once the media is provided to the exchange application 38, and is analyzed and configured for proper categorization, valuation and media clearance (for example, technical specifications, available access by media users, meets various legal clearance standards) the media will be posted for access by media users. The media is stored in the exchange database 30 in the particular provider's media account, and after clearance, the media user application 32 is then able to access the media from the exchange server 20. Once the media is offered to the media user application 32, the media user has the opportunity of accessing full content of the media by first executing a media user/exchange process 46.

During this media user/exchange process 46, the media user agrees to exchange a first media value for a second media value. Once the media user has agreed to this exchange (through various mechanisms such as a single pay per click), the media user can access the media through an exchange/media user process 44. The exchange application then sends the provider application 33, additional information on the use of the media by the media user application 32 through execution of an exchange/provider process 40.

Referring to FIG. 3B., a three party exchange operation 41 will be discussed. The exchange server 20 supports execution of the media user application 32 as well as the two sub applications of the provider application 33 as seen previously in FIG. 3 A., the advertiser application 34 and the media provider application 36. Generally speaking, the media user must first utilize or execute advertising media provided by the various advertisers utilizing the advertiser application 34, to accrue a media value amount. The media user may also fund their particular account by utilizing an outside financial institution to purchase media time or media value amounts for accessing the entertainment media.

Once the media user application 32 has accrued a media value amount, the media user can apply this media value amount towards the accessing of various entertainment media provided through the media provider application 36. Thus the advertiser utilizing the advertising application can push various advertisements for viewing towards various media users and the media users in exchange for viewing the advertisement can access the entertainment media of their choice. Lastly the media providers have a forum for receiving their media production.

Media and advertisements must first be posted on the exchange server 20 after being cleared and offered by the exchange application 38 prior to the media user application 32 having accessibility to the advertising media or entertainment media. The posting of the media and the posting of the advertisements are non-exclusive processes of one another, and either one can be performed first.

In general, the media provider will execute the media application 36 and upload the media content as well as other media content sensitive information such as media descriptions, pricing, updates and feedback, etc. . . . In order to perform this upload, the media provider application executes a media provider/exchange process 48. The media user application 32 then has access to the entertainment media. Once accessed, the exchange application 38 sends information back to the media provider application 36 through an exchange/media provider process 50.

Along similar lines, the advertiser application 34 uploads the advertisement media through the use of an advertising/exchange process 42. Once the media user application 32 accesses the advertising media, the exchange application 38 sends information back to the advertising application 34 through the execution of an exchange/advertisement process 40.

In this way, the media user application has access to “free entertainment media”, the advertiser application 34 sponsors the entertainment media provided from the media provider application 36 while the advertisement media and the entertainment media may be correlated together or not correlated together depending on the sorting capabilities and organizational decision making process of the media user.

Before discussing the navigation interface which provides for much of the media user application functionality, discussion of the various components of the media user application 32, the provider application 33, media provider application 36, the advertiser application 34, and the exchange application 38 will be provided.

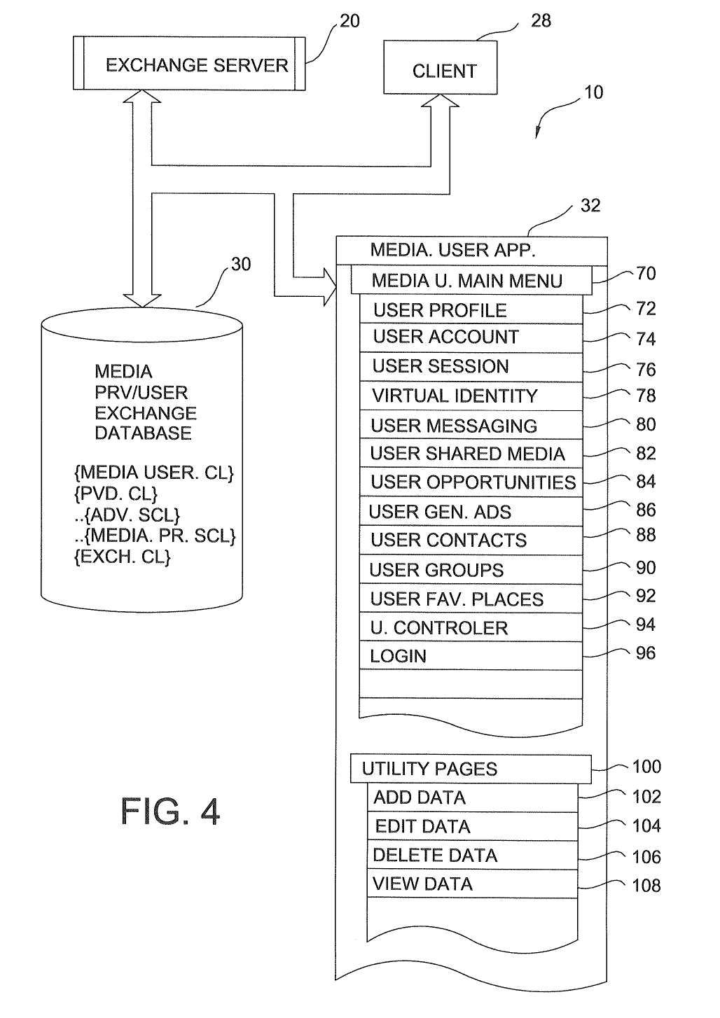

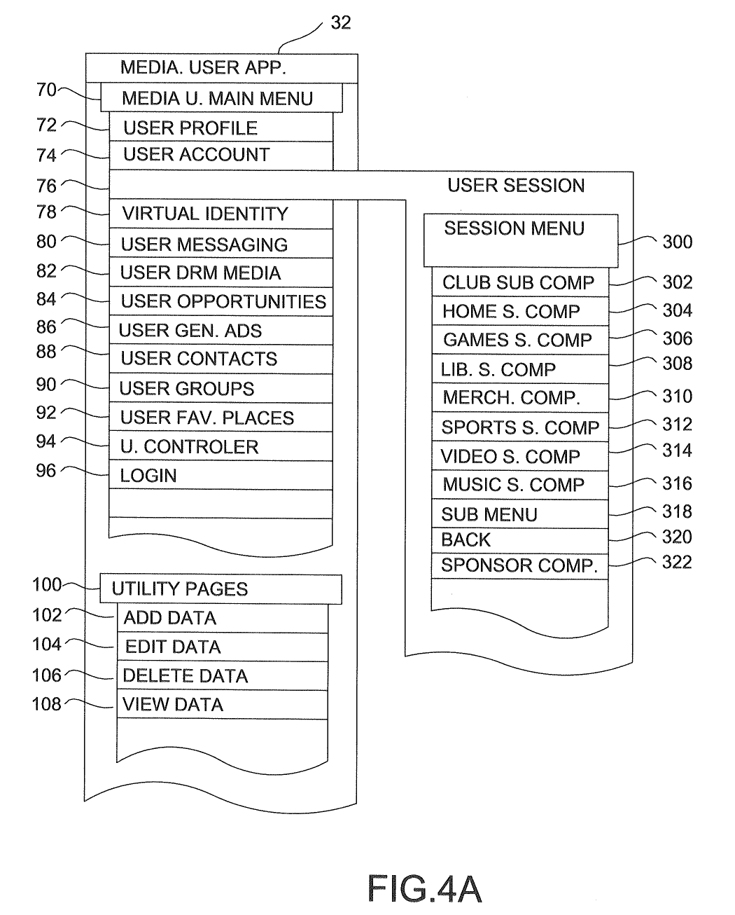

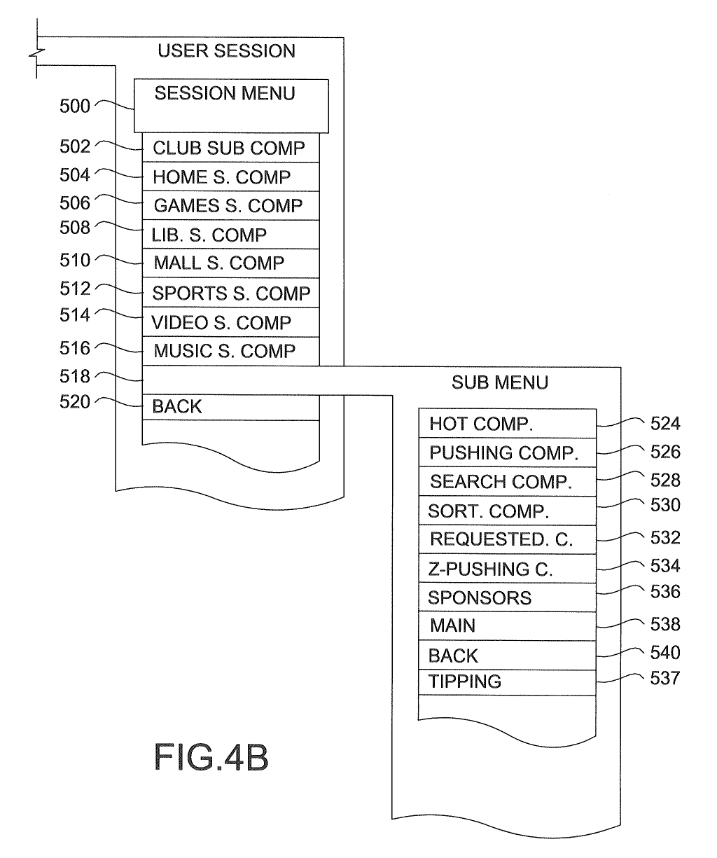

Referring to FIG. 4, the media user application 32 allows end-users of the exchange to view advertisements as well as entertainment media such as 2D and 3D games, 2D and 3D sites, video files, audio files, text files, and digital images. The audiovisual files include streaming video files for example from such sources as broadcast networks, Internet video, movie production companies, individual video producers, companies, etc. . . . These audio and video formats include but are not exclusive to, Ogg Theora, Ogg Vorbis, MOV, AVI, ASF, MPG, MPEG, MP4 video, real video etc. . . . The audio files include Ogg, FLAC, WAV, AIFF, MP3, MP4, and most other audio formats. The various image formats include PSD files, TIFF, JPG, PNG, GIFS, BMP, TGA, IFF, PICT, etc. . . . In addition to various audio and video and digital image formats, other file formats including XML, DOC, XLS, RTF, PDF, and other Microsoft or Apple document file formats. Games or game engines include but are not exclusive to the use of Flash, Torque Game Engine, TV3D SDK 6.5, 3D Game Studio, C4 Engine, Unity-3D, NeoAxis Engine, DX Studio, 3Impact, Beyond Virtual, Deep Creator, as well as Notable open source engines such as: Crystal Space—A free portal based engine, Game Blender—A sub-application of Blender, Irrlicht—A simple free open source 3d engine, The Nebula Device—A powerful engine used in many commercial games, Ogre3D—A well known LGPL graphics engine, Open Dynamics Engine—A cross platform physics engine used in many commercial games, Panda3D—Full featured Python/C++3D engine, Wolfenstein 3D engine till id Tech 3, etc. . . .

Still referring to FIG. 4, generally speaking the user application has a main menu component 70 which enables the entertainment or media user to develop a user profile 72, which would include such user information as name, age, gender, geographic location, address, preferences for entertainment and or advertising, and other interests. In addition to a user profile, a user account component 74 is provided where the user can accumulate and deduct media value in the form of credits and debits for use in accessing and interacting with media component files.

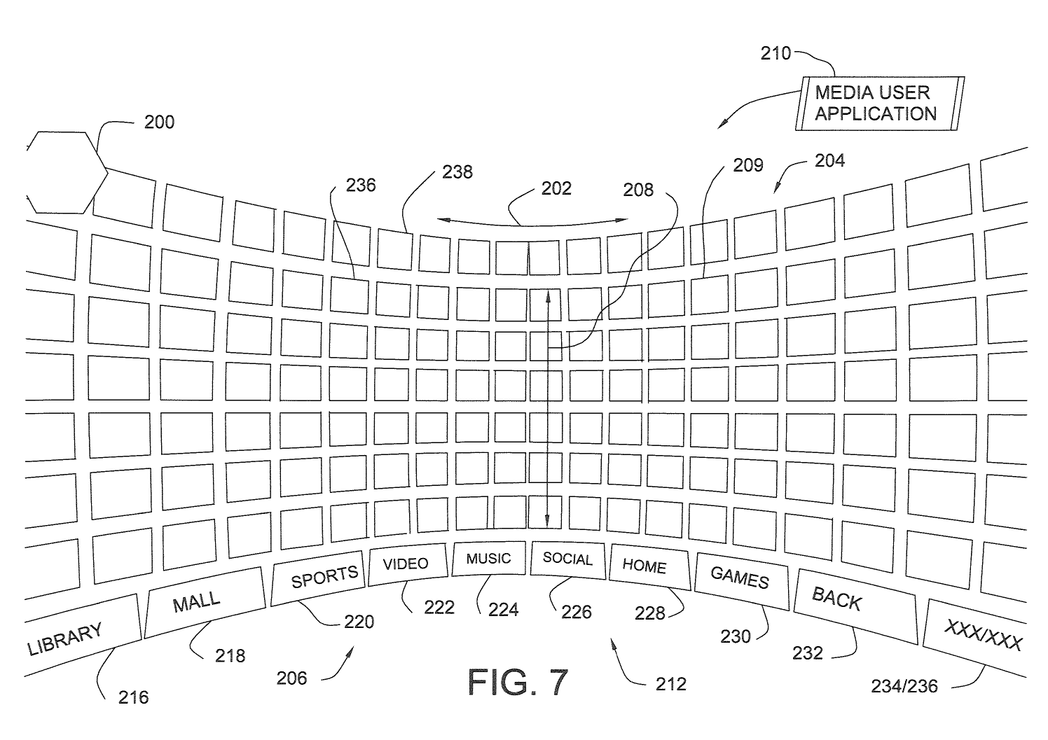

A user session component 76 is provided enabling the user to initiate a media navigation interface session through the use of a 2D or 3D navigation interface 210 as seen in FIG. 7 below. Furthermore the media user has the opportunity to develop various avatars or virtual identity representation components 78. These virtual identity components 78 enable the user to develop an online presence for use in virtual transactions such as social sites, 3D commerce worlds, discussion forums etc. . . .

The user media application 32 also enables the media user to communicate through various user messaging components 80 which include e-mail, text messaging, instant messaging, voice over Internet protocol, video over Internet protocols, and combinations of the above. The media user application 32 also enables the user to control or access various shared user media components 82.

In other words, the user may have purchased, acquired, created or own pre-existing media components to which the media user wishes to share or disseminate on the exchange server 20. In doing so, the media user then becomes a form of media provider and has some or all of the utilization of the media provider application 33 depending on the use license between the exchange and the media user.

During the online session, the media user may receive depending on the user's account settings, various user opportunity component's 84. These user opportunity components may be other media provider components such as advertisements, games, videos, music, or images which may allow the media user to acquire additional media value or expend stored media value depending on the opportunity.

For example, one embodiment may occur where the media user application has a setting for allowing certain types of media advertisement component's based on the user profile and user account settings to occur within the media user opportunities component 84. The correlated media value amount for viewing of the media advertisement component would enable the media user through use of the media user application 32 to execute the media advertisement component and acquire additional media value or in other words add additional media credit to the users account for use in accessing other desired entertainment media component's.

In addition to the user opportunity component 86, a user generated ad media component 82 enables the users if they do produce their own media, to advertise this media to other media users which utilize the exchange. The media user may aggregate or belong to various media user group component's 90. The media user may group various types of media which the media user has purchased, the media user may affiliate with various media groups, or the media user may have various types of media for sharing or dissemination to other media users through the exchange so that the media user can categorize and share or offer the media components within the various media user group component's 90. The media user may have media user favorite place component's 92 which enables the media user to develop a customized media navigation tool. Furthermore, the media user may have various media user controller components 94. These media user controller components 94 are affiliated with the types of media user client systems such as the media users high-definition television within the media users home, the media user's computer PC located at the media users home or office, or the media users personal digital device, such as the Internet/wireless/networking enabled cell phone or PDA.

The media user has a log-in component 96 enabling the user to have private access to the media user's custom application. Various utility pages 100 enable the media user to add data at component 102, edit the data component 104, delete the data at 106, or view various types of data at 108.

Referring to FIG. 4A, in order to provide for navigation of the media user application 32, the user session component 76 has a number of session menu subcomponents available for navigation through the session menu 300. These subcomponent menu navigation items enable the user to organize and navigate existing, proposed, sponsored or offered media. These session menu components include a sponsor subcomponent 522 club subcomponent 502, a home subcomponent 504, a game subcomponent 506, a library subcomponent 508, a merchant sales subcomponent 510, a sports subcomponent 512, a video subcomponent 514, a music subcomponent 516, a sub menu subcomponent 518, and a back menu subcomponent 520. A detailed discussion of the various subcomponents as they are executed and accessed will now be provided.

The sponsor subcomponent 522 allows media users to accrue media value credit for use in other components or subcomponent's within the system.

The club subcomponent 502 is the media user's public space. In other words, any other media user or media provider utilizing the exchange can search according to the content which the media user provides in the club component 502. In this particular location, media users utilizing their virtual identity components 78 which in one form may be an avatar, can interact with other media users within the exchange. The media users can execute various user messaging components 80 as previously discussed, to communicate and interact within the club component 502. In providing the communication, and developing relationships, the media users can allow or restrict other media users from accessing their home subcomponent 504. In the home subcomponent 304, users will be able to provide for private social networking etc. . . .

The home subcomponent 504 is non-searchable and closed to outside media users. Through the offering of a key or password, the media user can offer other media users utilizing the exchange, access to the home subcomponent 504. Users can draft a blog, maintain various text files, media files, such as digital images, audio files, video files, game files, and links to purchased or licensed digital media accessed from within the exchange.

The media user can access their user contacts maintained within the user contact component 88, various user groups within the user group component 90, develop their own media, including entertainment media or advertising media, as well as maintain work or school information, depending on the area of expertise.

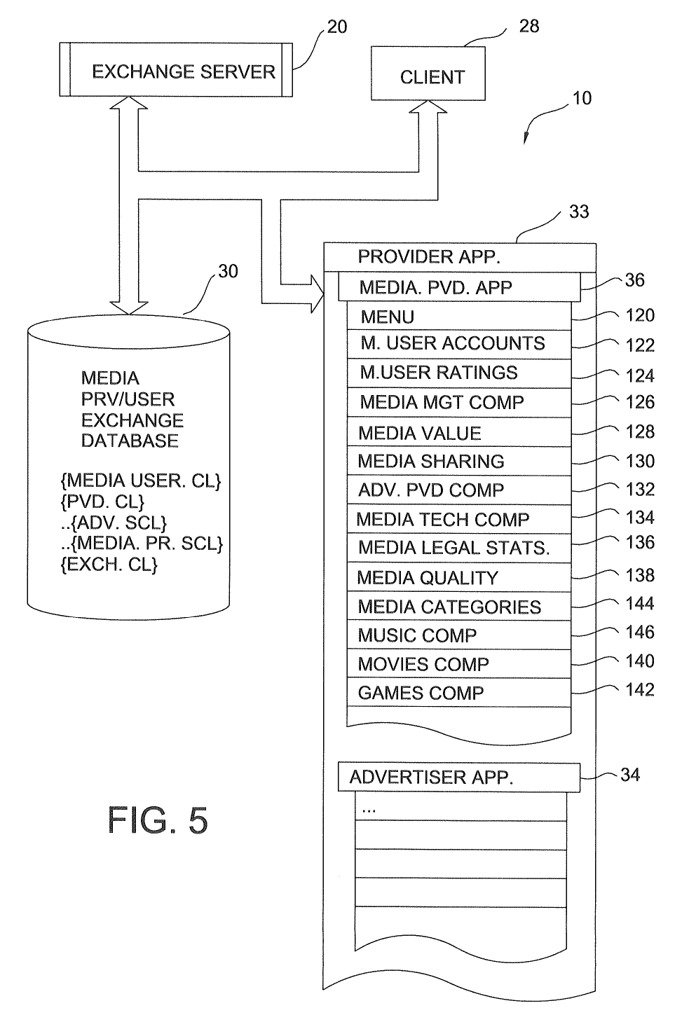

The game subcomponent 506 is where users can collect and play all offered videogames within the exchange. In general, from the media user perspective, all games are offered on a media value exchange basis. In other words, the media user must accrue media value credit to access the game media components 142 (FIG. 5). In one embodiment, a real world value of five cents to ten cents per media game component can be set through use of the media cost component 128 (FIG. 5). In other embodiments, the media value may be set at zero, at a positive amount, or at a negative mount depending upon the media providers choice of providing incentive-based gameplay, free-based gameplay, or pay-based gameplay.

Within the game subcomponent 306 the media user can communicate and give feedback to the media provider through the use of the user messaging component 80. Optionally, the media provider of the game may enable the media user to provide user content development for submission and integration into the particular game component. The game subcomponent may have optional limited play phases, where for example the play ranges from one to ten minutes depending upon the media provider settings. At the end of each game session, the media user may be prompted to continue that particular game for additional media value before the game session resets.

Some of the game subcomponent 306 categories include a popular or hot sub component, a media user collection subcomponent, a casual gaming subcomponent, a strategy gaming subcomponent, a role-playing game subcomponent, a first person shooter subcomponent, sports game subcomponent, a puzzle gaming subcomponent, a game sponsorship subcomponent, and combinations of the above.

In addition to games, the exchange will provide access to educational media through a library subcomponent 508. Here the media user can access large amounts of educational content, teaching games, research, news, reports, magazines, and other high density digital educational media which utilizes either a combination of digital text, digital images, digital audio files, digital video, or three-dimensional game object. From the educational media provider standpoint, local, regional, and higher education facilities are able to provide their multimedia content through the media exchange.

Another subcomponent under the media user session menu is the merchant sales component 510. The merchant sales subcomponent 510 enables providers having online storefronts to list their storefronts or websites within the merchant sales component category of the media user's navigation interface. For example, the user may have the option to view various offers or deals of the day from the online merchants, keep track of favorite store selections, view various preselected or configured merchant advertisements, search for a specific type of merchant, view the news and latest events in the merchant area, access a virtual shopping center, access a virtual Civic Center, access various classified listings etc. With the accrued media value which has been stored in the media users account component 74, the media user can exchange media value credit for merchant retail goods or services which may be delivered to the media users address listed within the user profile account component 72.

Still referring to FIG. 4A, a sports subcomponent 512 is a further categorization of the media being provided through the media user application 210 as seen in FIG. 7, which lists various sporting events and/or sport categorizations based on sporting type, region, user favorites, popularity, and other sortable attributes of the sporting media. The user may select or categorize various pro sports selections, college sports selections, motorsports, archived sport events, search for various sporting events, view various sporting events offerings, view a sports subcomponent collection, or keep track with the latest events in the sporting industry.

The video subcomponent 514 provides for initialization of the media provider video components 140 (FIG. 5) being offered to the particular media user through populating of the media matrix 208 (FIG. 7) based on the media user video media selections. In other words, the user may choose popular videos to view, various media user video collections, various media user individual video productions, various Internet or broadcast television selections, various syndicated television shows, various media channels, various movie selections.

The music subcomponent 516 enables the user to access digital music through the exchange. Similar to the previously mentioned session menu 300 subcomponents, the music subcomponent 516 provides for initialization of the media provider music components 146 (FIG. 5) being offered to the media user through populating of the media matrix 208 (FIG. 7) based on the combination of media user selections and media provider offerings. In other words, the media user can select from one embodiment, popular music selections, a preselected collections, various free offerings, search for a particular title, choose a music component through a category listing, choose a music component through a requested listing, choose a music component through a similar music categorization algorithm, choose from a series of music video components.

Referring to FIG. 4B, each of the session menu components within the session menu 300 have additional subcomponent menus 518 which enable the media user to further categorize and sort the media provided in each of the previously discussed session menu components. The submenu component 518 provides a popular or hot component 524, a pushing component 526, a search component 528, a sort component 530, a most requested component 532, a sponsorship component 536, a tipping component 537, and a return component 540 to the main menu.

With regard to the search component 528, it has a series of search submenus, including search by title, search by keyword, search by category, search by female artist, search by male artist, search by band or group, search by sponsorship. Along the same lines, the sort menu component 530 has a popular sort operation, an alphanumeric sort operation, a categorization sort operation, a sort operation by artist, a most requested sort operation, a group or band sort operation, a sponsorship sort operation, and album cover characteristic sort operation (for example sorting the music components by album cover color) and a return to the main menu.

The tipping component 537 allows a media user to transfer a media value credit to a media provider or media advertiser without requiring the media user to purchase the media component. For example, a media user may have access to the music component 146, which is being offered by the media provider for a zero or near zero media value cost. During or after listening to the music media component, the media user may execute the tipping component 537 and transfer to the media provider a media value credit. In addition to the tipping aspect of this process, the exchange can publish the number of tipping media value credits the media provider has received for the particular music media component as a rating of the popularity of the particular music media component.

The tipping component 537 can be utilized during any of the media users accessing of the media providers media content, such as the music component, movie or video components, and game components.

In addition to the navigation components, the media user application 32 has a media user controller 94 which in one form is configured as a heads-up display apparatus providing controls for the various types of media being played or initiated. The media user controller 94 includes a play operation, stop operation, pause operation, a continuous loop operation, the fast-forward operation, a rewind operation, a volume control and a return to the main menu.

While all of the menus and submenus are interconnected and can be accessed through forward and backwards tool navigation or a drilling down through a navigation tree, the users may be able to reconfigure the navigation controls as well as search from any screen. One embodiment of the navigation interface will be discussed in further detail below.

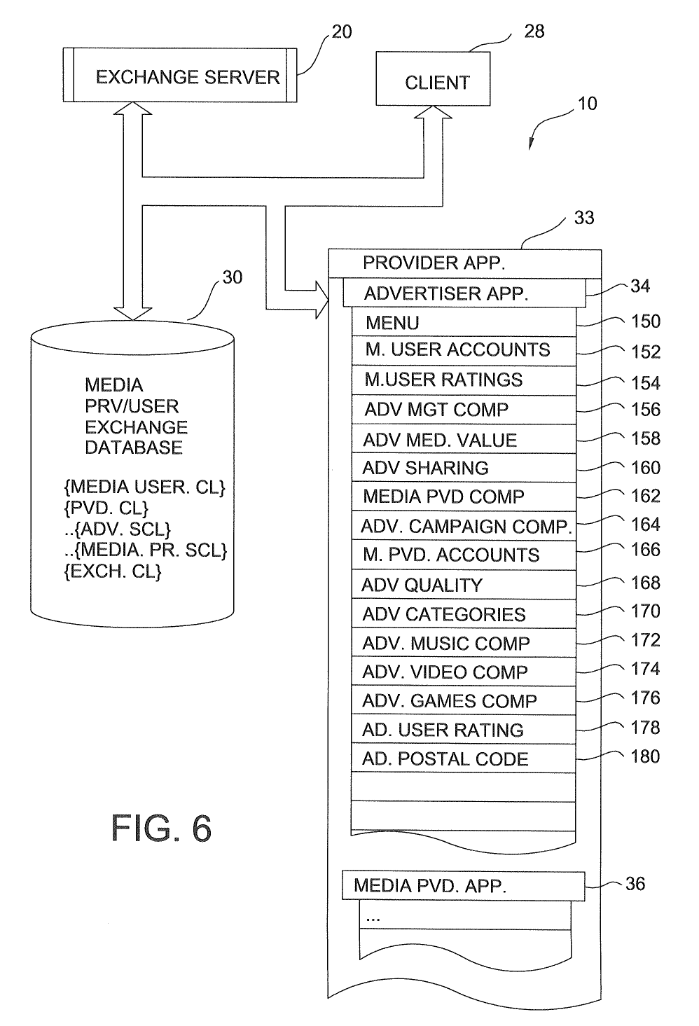

Referring to FIGS. 5 and 6, detailed discussion of the provider application 33 main component and it's subcomponents including the media provider application 36, the advertiser provider application 34, including their respective operational components will now be provided. With regard to the advertiser provider application component 34 and the media provider application 36, both provider applications have media content in which they are providing to the media users. One difference between the two is that the advertiser provider application 34 may have a media component which has an associated positive media value, whereas the media provider application 36 may have a media component which has an associated negative media value although this is not always the case.

The media provider application 36 has associated with it various sub components including the media provider menu component 122 which enables the media provider to manage their media provider accounts. The media provider application 36 also keeps track of the media user accounts accessing the media providers content, for example the media user account component 122 which enables the media provider to track the media users who have access to or utilize the media providers content such as the videos, music, games, or other information. The media provider can receive feedback from the media users through a media user rating component 124. When managing the various types of media, the media provider will utilize a media management component 126 which enables the media provider account holder to create, modify, assign different types of entertainment ratings or categories, name various entertainment or media components, link to various URLs, manage and assign various quality codes, resolution, as well as detail entertainment or media being provided, assign various legal statuses, provide a media value associated with the media component itself, thus creating a unique media ID component.

A more detailed discussion of the media management component 126 will be provided. Reference to other components that the media management component 126 operates with will first be provided. The media value component 128 is the associated debit or credit amount required by the media provider for the media user to access the media component. The media sharing component 130 is the setting for the level of access the media provider allows the media user to obtain for the exchanged media value. For example the media provider has set certain access restrictions to the game component 142 which may include full download of the entire game with a one time use, a multiple time use, or a full unrestricted single use license. The media provider may restrict access to a streaming media version with unlimited play or limited play, all based on media value credits or debit depending on the particular component settings.

The media provider may wish to also utilize the advertiser provider component 34 and therefore a subcomponent of the media provider application 36 is enabled for the media provider to advertise on the exchange utilizing a media/advertiser provider component 132. This is just another extension of the provider application 33 enabling both media provider and advertising provider to manage both types of media.

As discussed above, the media provider may have various settings for the media technology, which can be managed through the media technology components 134. The media legal status component 136 enables the media user to assign a legal status to the media. This may include an indication that the media is free of any potential intellectual property rights infringement, obtained from a trusted known source, or provided from an unknown or untrusted source.

The media quality component 138 provides the media provider with the ability to set minimum or maximum picture quality code, game-play code, music quality code, or video quality code depending on the media provider's original media quality and requested bandwidth. The media category component 144 enables the media provider to set the desired categorization of the media component being provided. The categorization would fall into categories which fit the previously mentioned media user subcomponents such as the game's subcomponent 306, Library's subcomponent 508, merchant sales subcomponent 510, sports subcomponent 512, video subcomponent 514, music subcomponent 516, etc. . . .

The media component itself is essentially a digital file. The media provider maintains the original media files which may take the characteristics of a music component 146, a video component 140, a game component 142, or combinations or sub combinations of the same depending on how the media provider develops and combines the media digital files.

A discussion of the advertiser provider application 34 will now be provided. An advertiser user menu component 150 is provided enabling the user of the advertiser provider application 34 to navigate within the application. The advertiser provider can manage and keep track of the individual media users who access their advertisements to obtain media value through the use of the media user account component 152. Similarly, the advertiser provider can manage and receive feedback from the media users through the media user ratings component 154. The advertising provider can also manage the advertising media uploaded to the exchange server through the use of the advertising management component 156. This advertisement management component 156 enables the advertising provider to create, modify, assign various types of ratings and or categories, name various advertising media components, link to various URLs, manage and assign various quality codes, resolution, and detail the advertising media being provided, as well as assign various legal statuses, provide an advertising media value associated with the advertising media component itself, thus creating an advertising media ID component.

Similar to the media value component 128, the advertising media value component 158 is the associated debit or credit (which may be a positive, negative, or neutral) amount provided by the advertising media provider to the media user which enables the media user to access the entertainment media components as previously discussed in FIG. 5. The advertising media sharing component 160 is the setting for the level of access of the advertising media from which the provider allows the media user to obtain certain amount of media value for viewing the advertising media component itself. For example, the media user may wish to access the previously discussed video game component 142. In order to do so, the media user must first accrue a certain amount of media value by accessing the offered advertising media components provide through the exchange, such as the advertising music component 172, the advertising video component 174, or the advertising game component 176. The advertising media provider may put restrictions on the type and amount of times the media user can access the advertising media components to accrue media value. This may include restriction on the number of visits in a certain timeframe, restrictions on the amount of media value accrued to that particular media user based on their user profile, etc. Also, the advertising media provider may limit certain levels of media value to specific levels of media user interaction with the advertising media component itself.

The advertising provider may also wish to utilize the media provider component 36 therefore a subcomponent of the advertising or advertiser provider application 34 is the media provider component 162. Again this is just another extension of the provider application 33 enabling both media provider and advertising provider manage both types of media these choose to do so.

One of the main reasons for providing the advertising is to develop an advertising marketing campaign. Thus the advertiser provider application 34 has an advertising campaign component 164 which enables the advertiser to create custom targeted advertising campaigns toward specific types of end media users.

In addition to managing the advertising campaign, the advertising provider also needs to keep track of any media provider accounts with which they may have affiliations. Therefore a media provider account component 166 is provided to help the advertiser provider manage the media provider accounts associated with that particular advertiser. The advertising media provider may also wish to add various levels of advertising media technology which can be managed through the advertising quality component 160. The advertiser may have various categories of advertising media and these categories are set and managed in the advertising category component 170. The digital files themselves will generally be the same as the media components files, and they include an advertising music component 172, advertising video component 174, and an advertising game component 176.

A detailed discussion of the various embodiments of the media user application interface 210 as seen in FIG. 7 will now be provided. In general, the media user application interface 210 can be executed in a web-based version or executed through a downloadable software component version, or combination of the two. The interface may be represented in a two-dimensional format, a static three-dimensional format, or a four dimensional virtual reality-based format where the three-dimensional object of the media user application interface is utilized within a virtual interactive environment.

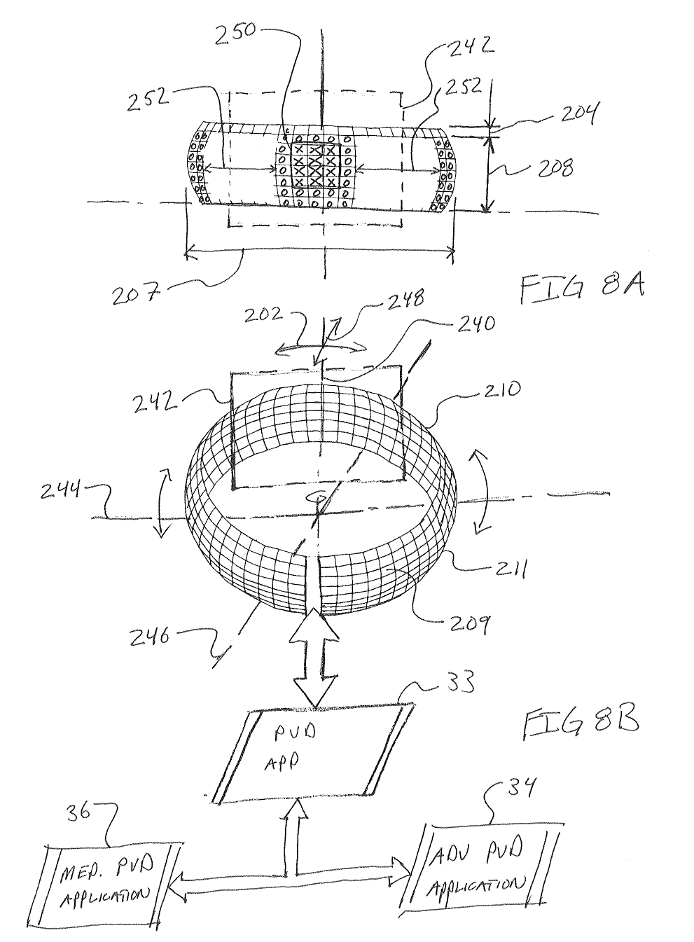

Referring briefly to FIG. 8B, the media user application interface 210 in the three-dimensional version may be configured as a semi spherical three dimensional object (other shapes are readily envisioned within the scope of this embodiment). The object may be manipulated utilizing a three-dimensional physics engine as previously discussed. In this particular embodiment, the physics engine utilized is a unity3D platform. In one embodiment, the user interface is limited to a view frame 242 which enables the media user to execute a media user application within a browser or within a local client application, and operate the interface within a two-dimensional or three-dimensional navigation setting. The user may be able to scroll side to side and scroll vertically thus enabling a two-dimensional operation. In addition, the user may be able to scroll or zoom in and out of the page to certain predefined limits. In a virtual environment, the user would be able to utilize the 3D navigation interface 210 as a three-dimensional object within the gaming environment. Here the user would be able to move and scale the object in 3D representation portable within the environment, and then execute the object to a viewable implementation of the interface, where the navigational controls are utilized within a view frame 242 within the virtual environment.

In the following embodiment, the user would be using a 3D interface placed within a browser or view frame 242. The user will be able to scroll vertically along the central axis 240, as well as scroll circumferentially in a scrolling direction 202 and zoom for a closer or more distant perspective in a zoom scroll 248 direction. The application interface 210 has a plurality of media tiles 209 which are three-dimensional navigational placeholders of the media components or the advertising components. Referring to FIG. 8A, the media tiles 209 are scrollable in and out of the view frame 242 as the user operates the navigation interface 210. The user view frame 242 maintains a static position where the center of the view frame is focused on a primary media tile location 250. This is where the media tiles 209 maintain a permanent position with the view frame 242. Outside of this primary media position 250 are secondary media view ranges 252. The top row of the media tiles within the user navigation interface 210 acts as a media docking location 204.

As the user scrolls from left to right, the media tiles 209 moved in and out of the primary focus media tile location 250. The browser application or the client application of the media user application 32, is interoperating with the provider application 33 and being loaded with media based on the particular media user application account settings, profile settings, preferences, exchange data mining and direct search capabilities. The media user application 32 continuously interoperates with the provider application 33, sending and receiving a constant stream of media tile components 209 in and out of the media matrix 208 (FIG. 7).

As previously discussed, the exchange application 38 coordinates the interoperation between the media user application 32, the provider applications 36 and 34, and the exchange server 20. The exchange application 38 coordinates the media component lists, user accounts, media provider accounts, advertising provider accounts, and other applicable media information with the actual media components provided as just in time media component files to the media user application 32. Once the media user application has selected a media tile 209 to view or execute the underlying media components links, the exchange application will clear and provide the media file to the media user application. With an unlimited number of media providers or advertising providers, the provider application 33 can queue in line depending on the exchange priority settings of the media providers, and unending series of media tiles 209 to feed into the media matrix 208.

Furthermore, the exchange application 38 coordinates the accounting between the media value provided by the media user, the media value required by the media provider as well as the media value offered by the media advertiser.

Briefly referring to FIG. 3B, with the media users application 32 having initialized the media user application navigation interface 210, the media user accesses a media tile 209 through the exchange/media user process 44. The media user application 32 must clear a certain amount of media value to access the underlying media component with the representative media file. This occurs during the media user/exchange process 46. The exchange application 38 clears the media value for that particular media component file, and sends an authorization or an accounting amount during an exchange/media provider process 50. The media provider application 36 accounts for the media value credit in the accessing of the media component, makes certain media user access record notations, and authorizes or sends the media component file through a media provider/exchange process 48. The exchange application then authorizes the media user application 32 to access the media component file either through the exchange server, or by sending the media file through the exchange/media user process 44.

Still referring to FIG. 3B, if the media user application 32 wishes to a accrue a media value credit, the media user application may execute a media user exchange process 46 where the media user application visits the advertising provider side of a media matrix 208 by navigating to the advertising tile 234 or navigating to a sponsors submenu 536 (FIG. 4B) of the submenu component 518 to view the sponsoring advertisers of the particular media files that the media user is presently viewing. A detailed use discussion of the three party exchange operation 40 of FIG. 3B will be provided showing an implementation of the media value accrual to the media user from the advertising provider.

The media user application 32 after having initialized the media user navigation interface 210, will access a media tile 209 which has been sent to the end user application 32 through the exchange/media user process 44. This can also be seen in FIG. 8B, where the provider application 33 is sending in an instance of the advertiser provider application 34, the various media tiles 209 which correlate to advertising media components such as advertising video component 174 (FIG. 6). In order to accrue a certain level of media value credit, the media user application 32 executes the media user/exchange process 46 to access the underlying advertising video component 174 correlated to the media tile 209, and the exchange application 38 coordinates with the advertiser application 34 through the exchange/advertiser process 40 to record the media user request for accessing of the advertising media file or component and also verifies the requested amount of media value for that particular advertising video component 174, then execution is authorized by the advertising application 34. The advertising application 34 records the information sent by the exchange application 38, then either sends the advertising video component file or authorizes the accessing of the advertising/exchange process 42. The exchange application 38 then authorizes the media user application to view and accrue a media value credits.

Referring to FIG. 7, detailed discussion of the user operation of the three-dimensional media user application 210 will now be provided. The user can scroll between a plurality of session menu options which are representations of the session menu main navigation components as previously discussed in FIG. 4A. For example, the user will have the option of scrolling through a plurality of navigation main menu tiles 212. They include in one form a advertising or sponsor tile 234, library tile 216, a merchant sales tile 218, a sports tile 220, a video tile 222, a music tile 224, a social tile 226, a home tile 228, a games tile 230, a back tile 232, and a submenu tile 236.

A basic example for accessing a music file will be provided. The user scrolls to the music tile 224. The media matrix 208 populates with the available music components 146 according to the user's media preferences as maintained in the media user profile component 72, FIG. 4A. The user may choose to listen to one or more of the presented music components which are executable by either clicking or selecting in some form the media tile or media component link 214 which represents the media music file or component which the user is interested in accessing. If the user immediately selects the media component link 214, that particular component link will execute.

In one embodiment, the system checks to determine if the media user has sufficient media value in their media value account 200 which is reflective of the media users account component 74. If the media users account 74 has enough media value within it to support the accessing of the music media component 146, for that particular media component link 214, then the media user can access the various forms of the media component which are allowed by the media provider and controlled through the media sharing component 130 (FIG. 5). The user may wish to place a series of miscellaneously chosen media components in a docking location 204, thus allowing for continuous media play. For example, the media user may access a certain number music media components 214 in the media matrix 208, and then place them by dragging and dropping these media and music components into the docking location 204. The user may then access the video menu 222, and then choose a video component to move to the docking location. Finally, the user may choose a game component to store for later access in the docking station.

The media user may wish to randomly display the media files within the media matrix 208. In doing so, the media user may randomize the media matrix display 208, providing for a mixed integration of media provider files or components and advertising files or components. Furthermore, the media user may wish to search for a specific media file or search within a category of media files for a range of displayed media. The search results will be returned within the media matrix 208 according to the relevancy of the search terms request by the media user.

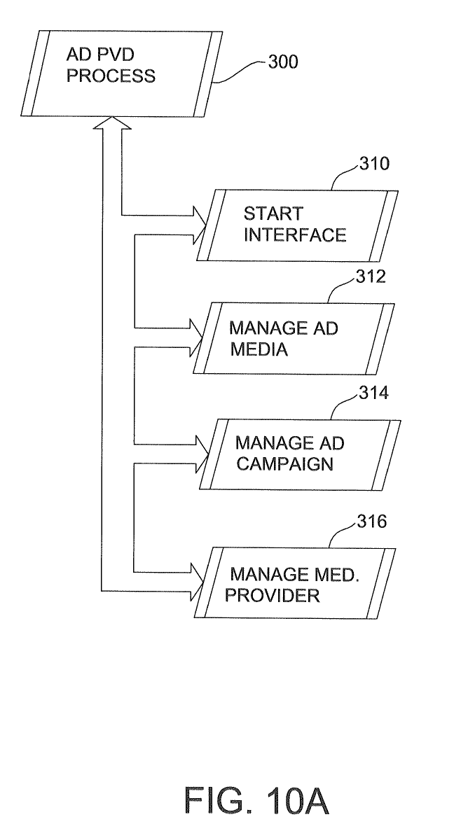

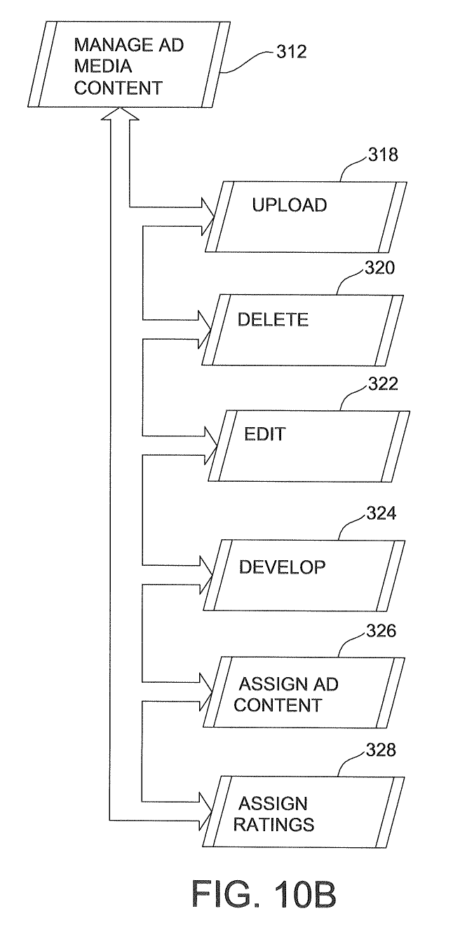

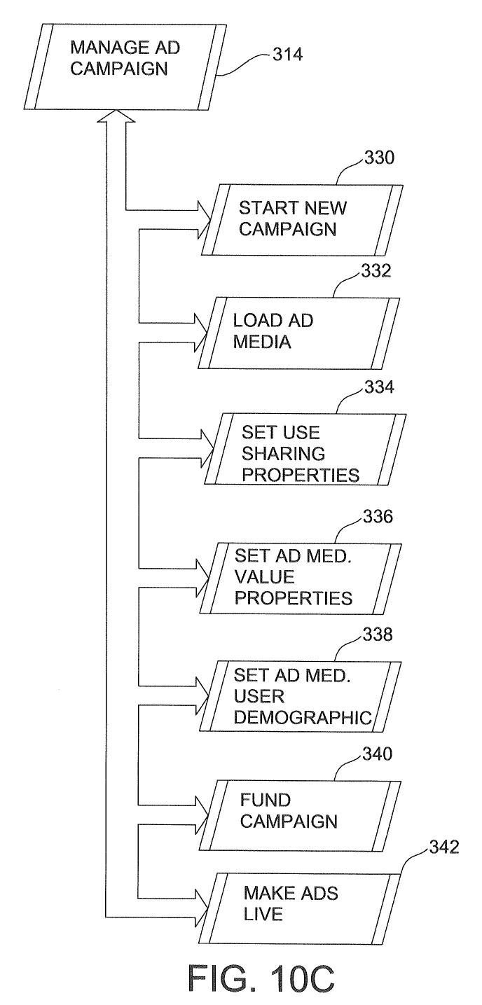

A discussion of the advertising provider process 300 will be provided with reference to the components of the advertising provider application 34 as seen in FIG. 6, as well as the advertising provider process 300 as seen in FIGS. 10A, 10B, and 10C. The advertising provider will start the advertising provider application 34 and begin the process at step 310. During this process, the advertising provider will also be able to manage ad media content at step 312.

Once the ad media content has been managed, the advertiser can develop and manage ad campaigns at step 314. In addition to managing ad campaigns, the advertising provider can produce develop, and manage their own media provider processes at step 316 which is an extension of the media provider application 36 (FIG. 5).

Referring to FIG. 10B, the advertising provider can manage the ad media content at step process 312 by uploading the ad media content at step 318. This includes uploading to the exchange, previously produced advertising provider music components 172 (FIG. 6), advertising video components 174, advertising game components 176, as well as other digital image files or text files. The advertising provider can edit or delete in steps 322 and 320 respectively, or the advertising provider can develop ad content at step 324 utilizing exchange provided advertising development tools. Once the advertising media is hosted on the exchange server, the advertising provider can assign added categories to the particular media at step 326 as well as ratings to the media at step 328.

With the advertising media listed on the exchange and listed within the advertiser providers account, the advertising provider can manage an ad campaign at step 314. Generally, this is where the ad provider determines the market focus of the ads and how they will be displayed and what it will cost. The ad provider can start a new campaign at step 330 and affiliate various ad media (previously uploaded) at step 332 with that new campaign. The ad provider can set the sharing or use properties at step 334 of the particular advertising media files or components.

For example, the advertising provider may wish to limit the view time of an advertising media components or restrict access to a particular age demographic, or restrict access to a particular gender demographic, or restrict access to particular geographic demographic. Furthermore, the ad provider may wish to limit the number of times a particular media user can access and obtain media value credit for viewing of that particular advertising provider media component. Also, the ad provider can set the amount that they are willing to pay the end user to view, play, read or experience their material. This may be based on three basic criteria, age, gender, and ZIP code.

The advertising provider can set the ad media value at step 336. For example, the advertiser can choose a blanket price for all users, or can be specific as to the target demographic. The advertiser can determine the price structure of the system by providing a pay-per-click option, a pay-per-view option, a pay-per-play, and pay for time spent with the advertiser, or a pay for purchase of an advertiser item or service.

Once the advertiser has set the value, the advertiser can as indicated above, set the ad media user demographics to a specific age, gender, or ZIP code at step 330. With ad value and demographic set, the ad provider can fund the particular campaign at step 340 and then at step 342 make the ad live on the exchange.

A detailed discussion of the implementation of this process will now be provided. For example, Burton snowboards signs up for an advertising account and starts the interface at step 310. Burton uploads a 15 second video commercial at step 318 which is then hosted on the server. Burton sets the price or media value at step 336 at $0.10 per view for males and females between the ages of 13 and 29 and a specific ZIP code. Once the ad campaign is fully configured, Burton makes the ad live at step 342 and the ad is provided to those particular media users meeting that particular demographic and is accessible within the media matrix 208 on the advertising listing 234 of the media user application 210.

With each user media application execution of the media tile 209 linked to that particular Burton advertiser video component 174, the exchange provides a media value credit of (10 credits) which may or may not be related to a real world currency value of $0.10. The exchange processes a transaction fee or brokerage fee in the amount of for example a percentage of the individual real world currency value of the media value credit and the advertiser provider account campaign fund is lowered by the sum total amount of the transaction or brokerage fee and the media value credit to the end-user.

According to the media users preferences and the media users profile component 72, the media users will be able to mark or indicate various industries or categories as favorites within which they wish to receive offers for advertising media. For example, a male media user of 24 years may wish to put sports and more specifically snowboarding on their favorite advertising media list. Only when the media user accesses the advertising or user opportunities component 84 of the media user application 32 which is represented by the media matrix 208 having the advertising representation of the media tiles 209, will the media user be able to view advertising offers for media value credits.

In determining the initial placement of the media tiles 209 representing the particular advertising media component, the advertising media components placed with the primary focus media location 250 (FIG. 8A) will be a combination of the media users preference settings and the advertising provider demographic settings and ad campaign funds settings.

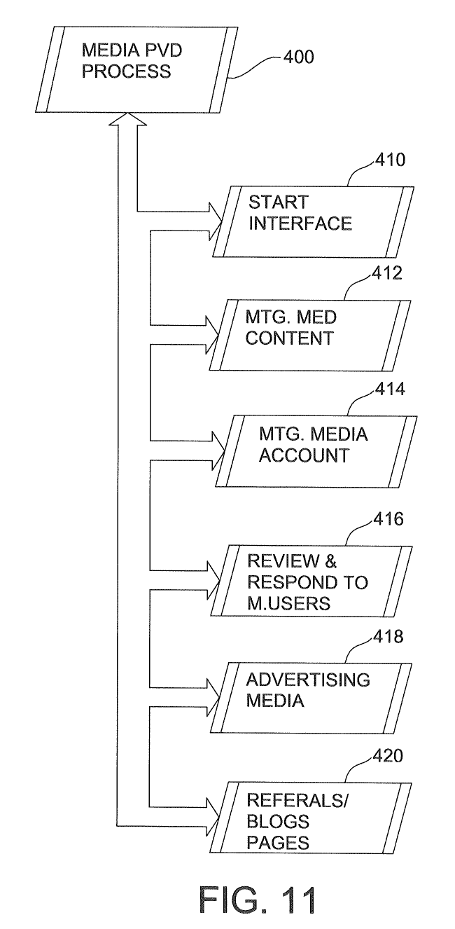

A discussion of the media provider process 400 as seen in FIG. 11, which is an execution of the media provider application 36 as seen in FIG. 6 and FIG. 3B will now be provided. Once the media provider has obtained the media provider account, the media provider can start the interface at step 410. The media provider can manage the media content at step 412 and optionally can manage the media campaign at step 414. In addition, the media provider can review and respond to media user communications at step 416, as well as provide advertising media at step 418 which is an implementation of the previously discussed advertiser provider process 300 is in FIG. 10A. Furthermore, the media provider can implement a referral or blog process at step 420.

The media provider can manage the media content at step 412 by uploading the media content which includes various media files such as the music media component 146, a video component 140, a games component 142, a digital image file component and a digital text file component. The media provider can edit, delete, or add to the pre-existing media files which have been uploaded to the exchange server. Furthermore, the media provider can develop media content utilizing an exchange provided media development toolset. Once the media is hosted on the exchange server, the media provider can assign various categories to each of the various media files, provide ratings, and manage the media file costs. With the media hosted on the exchange and listed within the media provider's account, the media provider can manage a media campaign at step 414.

Generally speaking, this is where the media provider will determine the media user focus and how the media files will be displayed and who will be able to access the media files through their respective media user applications 32 as implemented and navigated through the media user application interface 210. The media provider can set the media sharing properties 130, thus determining which media users would be able to access and utilize the media files. For example, the media provider may wish to limit the view time of a media component, restrict access to a particular age demographic, gender demographic, or geographic region.

Furthermore, the media provider also may wish to limit the number of times a particular media user can access or obtain the media component for a certain media value cost to view that particular media component. Also, the media provider may wish to set the low, medium, or high amount that the media user must pay to view, play, read or experience their material in various quality formats.

By accessing the media value settings component 128, the media provider can set the value required for a media user to access the media components hosted by the media provider. For example, the media provider can choose a blanket price for all users to access one type of media component he may have listed on the exchange.

In another example, the media provider may only provide for a specific price across a particular demographic, or across a particular geographic region. The price as previously discussed during the system architecture discussion, may be limited to a negative media value, a zero media value, or a positive media value depending upon the media providers interests in disseminating the particular media components. The media provider can determine the price structure of the particular media campaign by providing a pay per stream option, pay per download option, pay per time range option, pay per comments options, and other types of exchange processes.

Once the media provider has set the media value, the provider can as indicated above, set the media user demographics to specific age, gender, zip code or remove any limitations. With the media value and demographics set, the media provider can publish the particular media campaign and make the media live on the exchange.

A detailed discussion of the implementation of this process will now be provided. For example, NBC wishes to provide a new 30 minute sitcom for viewing on the exchange. NBC first signs up for a media provider account and starts the media provider process by initializing the interface at step 410. NBC, having completed the 30 minute video, uploads the video in the manage media content process step 412.

NBC sets the price for the video component at five media value credits. They set this price for males and females who are older than 18 within a specific ZIP code. Once the media video component is rated, priced, and the users are determined, NBC makes the media video component live and the media component is provided to those particular media users meeting the particular geographic and demographic settings and is accessible within the particular media users media matrix 208 on the video menu tab 222 of the media user application 210.

With each media user application execution of the media tile 209 linked to that particular NBC video component 140, the exchange provides a media value credit of (five credits) to the media provider. This media value credit may or may not be related to a real world currency value. The exchange processes the overhead costs of storing and delivering the content to the end user and then splits the “net” proceeds with the media provider, the media provider's account media fund is increased by the media value credit from the end-user.

According to the media users preferences and the media user's profile component 72, the media users will be able to indicate various entertainment types, categories, or favorites within which they wish to receive directed entertainment media. For example, a female media user of 30 years of age may wish to indicate romance and more specifically movies as one of their favorites in the entertainment media list.

Only when the media user accesses the video menu page 222 or the video subcomponent 314 of the media user application 32, will the media user has access through the media matrix 208 to various media tiles 209 showing the entertainment media for romance movies and be associated media value costs.

In determining the initial placement of the media tiles 209 representing the particular media components, the media components placed within the primary focus media location 250 (FIG. 8A) will be a combination of the media users preference settings and the media providers demographic settings and media component pricing structure.

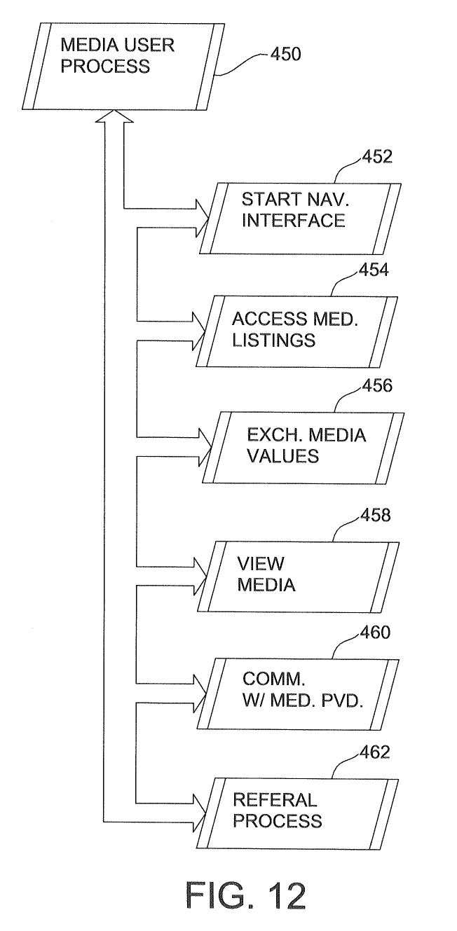

Referring to FIG. 12, a detailed discussion of the media user process 450 will be provided with reference to FIGS. 4A, 4B, FIG. 7, FIGS. 8A, and 8B, and FIG. 3B for implementation of various processes. Generally speaking, a media user will start the navigation interface at step 452 and implement in either their Web browser or local client application a media user application 210 as in FIG. 7.

In order to access the media listings at step 454, the media user must at some point during the navigation process accrue a certain number of media value credits which can be referred to and seen in the media credit amount 200. In order to accrue media value credits, as previously discussed, the media user can perform a media exchange process at step 456 or purchase media value through the financial institution 18. Here the media user will in one form access advertising components through the advertising menu 232 (FIG. 7) and the media user will view a series of media tiles 209 within the media matrix 208 which are representative of advertising media components which the media user can access to begin a media value accrual process based on an interaction with an advertising media component provided from an advertising provider.

Once the media user has accrued the media value credit from the advertising provider or the financial institution, the media user can then navigate to say for example a sports menu 220 within the media user application interface 210 and choose from within the media matrix 208 a media tile 209 which has the sport media content which would likely be a media video component 140.

The media user would exchange at least a portion of the accrued media value credit for the media value cost of the associated video component 140. The users media credit amount 200 would decrease by that media value cost amount and the media user would be able to view and access the media component provided from the media provider. This occurs at step 458.

The media user can also execute a user messaging component 80 and communicate with the media provider at step 460. The media user may be able to provide for feedback on the media content for that particular media video component 140 or the media user may wish to refer or recommend the media at step 462 to a friend or a social network.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A media exchange system, said media exchange system comprising:
a. a first exchange system database providing interoperation between a first exchange component, a first media user component, and a first media provider component;
b. said first media user component enabling a first media client to access a first media component; said first media component supplied from a first media provider client utilizing said first media provider component;
c. said first media user component further enabling said first media client to enable said first media component and accrue a first media value; and
d. said first media user component enabling said first media client to access a second media component associated with a second media value by exchanging said first media value for said second media value.

2. The exchange system according to claim 1 wherein said first media value further comprises: a media credit amount.

3. The exchange system according to claim 1 wherein said second media value further comprises: a media debit amount.

4. The exchange system according to claim 1 wherein said first media component further comprises: an advertisement media component.

5. The exchange system according to claim 1 wherein said second media component further comprises: an entertainment media component.

6. The exchange system according to claim 1 wherein said first media user component enables said first media client to access said first media component from a first group of media components.

7. The exchange system according to claim 6 wherein said first group of media components further comprises: a first group of advertising media components; said first media component further comprising: a first advertising media component associated with a media value credit amount.

8. The exchange system according to claim 1 wherein said first media user component enables said first media client to access a second media component from a second group of media components.

9. The exchange system according to claim 8 wherein said second group of media components further comprises: a second group of entertainment media components; said second media component further comprising: a second entertainment media component associated with a media value debit amount.

10. The exchange system according to claim 4 wherein said advertisement media component further comprises: a music component.

11. The scene system according to claim 4 wherein said advertisement media component further comprises: a video component.

12. The exchange system according to claim 4 wherein said advertisement media component further comprises: a game component.

13. The exchange system according to claim 4 wherein said advertisement media component further comprises: a music component; a video component; a game component.

14. The exchange system according to claim 13 wherein said advertisement media component further comprises: an image component; a text component; a 3-D model component; a virtual store component.

15. The exchange system according to claim 5 wherein said entertainment media component further comprises: a music component.

16. The exchange system according to claim 5 wherein said entertainment media component further comprises: a video component.

17. The exchange system according to claim 5 wherein said entertainment media component further comprises: a game component.

18. The exchange system according to claim 5 wherein said entertainment media component further comprises: a music component; a video component; a game component.

19. The exchange system according to claim 18 wherein said entertainment media component further comprises: an image component; a text component; a 3-D model component; a virtual store component.

20. The exchange system according to claim 1 wherein said first media user component further comprises: a navigation interface component.

21. The exchange system according to claim 19 wherein said navigation interface component further comprises: a two-dimensional navigation interface.

22. The exchange system according to claim 19 wherein said navigation interface component further comprises: a three-dimensional navigation interface.

23. The exchange system according to claim 19 wherein said navigation interface component further comprises: a three dimensional navigation interface operable within a virtual environment.

24. The exchange system according to claim 19 wherein said navigation interface component further comprises a media matrix, said media matrix configured to display at least one media tile, said at least one media tile relating to at least one media component.

25. The exchange system according to claim 24 wherein said at least one media tile further comprises an entertainment media tile relating to at least one entertainment media component.

26. The exchange system according to claim 24 wherein said at least one media tile further comprises an advertising media tile relating to at least one advertising media component.

27. The exchange system according to claim 24 wherein said media matrix further comprises a primary focus range; a secondary focus range.

28. The exchange system according to claim 7 wherein said first group of advertising media components further comprises: a first group of music components.

29. The exchange system according to claim 7 wherein said first group of advertising media components further comprises: a first group of video components.

30. The exchange system according to claim 7 wherein said first group of advertising media components further comprises: a first group of game components.

31. The exchange system according to claim 9 wherein said first group of entertainment media components further comprises: a first group of music components.

32. The exchange system according to claim 9 wherein said first group of entertainment media components further comprises: a first group of video components.

33. The exchange system according to claim 9 wherein said first group of entertainment media components further comprises: a first group of game components.

34. The exchange system according to claim 7 wherein said first group of advertising media components further comprises: a first group of music components; a first group of video components; a first group of game components.

35. The exchange system according to claim 9 wherein said first group of entertainment media components further comprises: a first group of music components; a first group of video components; a first group of game components.

36. The media exchange system according to claim 1 wherein said first media provider component further comprises: a first advertising media provider component.

37. The media exchange system according to claim 1 wherein said first media provider component further comprises: a first entertainment media provider component.

38. The media exchange system according to claim 36 wherein said first advertising media provider component further comprises:
a. an advertising music component; an advertising video component; an advertising game component; an advertising campaign component, and an advertising media value component;
b. said first advertising campaign component configured to load said advertising music component, said advertising video component, and said advertising game component;
c. said advertising campaign component further configured to assign an advertising media value component to said advertising music component, said advertising video component, and said advertising game component;
d. said advertising campaign component further configured to provide said advertising music component, said advertising video component, and said advertising game component, to said first media user component through said first exchange component.

39. The media exchange system according to claim 37 wherein said first entertainment media provider component further comprises:
a. an entertainment music component; and entertainment video component; an entertainment game component; an entertainment campaign component, and an entertainment media value component;
b. said first entertainment campaign component configured to load said entertainment music component, said entertainment video component, and said entertainment game component;
c. said entertainment campaign component further configured to assign an entertainment media value component to said entertainment music component, said entertainment video component, and said entertainment game component;
d. said entertainment campaign component further configured to provide said entertainment music component, said entertainment video component, and said entertainment game component, to said first media user component through said first exchange component.

40. The media exchange system according to claim 37 wherein said exchange further comprises: said first media value further comprising: a media credit amount; said first media user component configured to access said entertainment music component, said entertainment video component, or said entertaining game component, by utilizing at least a portion of said media credit amount.

41. The immediate exchange according to claim 36 wherein said exchange further comprises: said first media value further comprising, a media credit amount; said first media user component configured to access said advertising music component, said advertising video component, or said advertising game component and accrue said media credit amount.

42. An entertainment system, said entertainment system comprising:
a. an entertainment digital display, said digital display further comprising: a high definition flat screen monitor, a high definition LCD display, a high definition display providing 1080p resolution, a high-definition display providing 720p resolution, a CRT display;
b. a signal reader component, said signal reader component comprising: a web cam, a wii remote interoperating with a plurality of infrared sources, a sonar reader, a heat sensitive reader;
c. an entertainment client, said entertainment client comprising: a laptop computer, a desktop computer, a boxed top game console, a processor interoperating with a hard drive and random access memory, a programmable logic controller maintained within said video display to interoperate with a web server;
d. a first entertainment user, said first entertainment user interacting with said signal reader component; said signal reader component interoperating with said entertainment client, said entertainment client interoperating with said entertainment digital display;
e. said entertainment digital display displaying a navigation interface component providing said entertainment client with access to a first group of entertainment media, a first group of advertising media, an exchange server;
f. said exchange server enabling said first entertainment client to access said first group of entertainment media and said first group of advertising media to accumulate a first media value credit from a first entertainment media provider.

43. The entertainment system according to claim 42 wherein said entertainment system further comprises: said exchange server enabling said first entertainment client to access said advertising media and accumulate said first media value credit.

44. The entertainment system according to claim 43 wherein said entertainment system further comprises: said exchange server further enabling said first entertainment client to access said entertainment media by utilizing said first media value credit to access said first entertainment media from said first entertainment media provider.
